(19) United States
(12) Patent Application Publication
(10) Pub. No.: US 2013/0091285 A1
(43) Pub. Date: Apr. 11, 2013

(54) DISCOVERY-BASED IDENTIFICATION AND MIGRATION OF EASILY CLOUDIFIABLE APPLICATIONS

(71) Applicants: Murthy V. Devarakonda, Peekskill, NY (US); Nikolai A. Joukov, Stony Brook, NY (US); Birgit Pfitzmann, Valhalla, NY (US); Shaya Potter, New York, NY (US)

(72) Inventors: Murthy V. Devarakonda, Peekskill, NY (US); Nikolai A. Joukov, Stony Brook, NY (US); Birgit Pfitzmann, Valhalla, NY (US); Shaya Potter, New York, NY (US)

(73) Assignee: INTERNATIONAL BUSINESS MACHINES CORPORATION, Armonk, NY (US)

(21) Appl. No.: 13/270,677

(22) Filed: Oct. 11, 2011

(51) Int. Cl. G06F 15/173

(52) U.S. Cl. 709/226

(57) ABSTRACT

Infrastructures of a plurality of existing applications of an entity are analyzed to identify at least one of the infrastructures of the plurality of existing applications which includes existing substructures enabling replication of individual parts via an existing replication mechanism. The at least one of the infrastructures is selected for migration to a cloud. The cloud includes at least one of an infrastructure as a service cloud and a platform as a service cloud. The existing substructures of the at least one of the infrastructures are migrated to the cloud, without application-level change. A business agility component is assembled and is configured to control extending and shrinking resources of the cloud that are devoted to the at least one of the infrastructures. The resources of the cloud that are devoted to the at least one of the infrastructures are extended and shrunk, using the business agility component.

### FIELD OF THE INVENTION

The present invention relates to the electrical, electronic and computer arts, and, more particularly, to cloud computing and the like.

### BACKGROUND OF THE INVENTION

Clouds are a currently topic of interest in industry. A current focus area is to design and implement new application programming models, and to build new applications according to these models. Examples are Google's map-reduce model (available from Google Inc. of Mountain View, Calif., USA) and Salesforce_dot_com's (Salesforce_dot_com, Inc., of San Francisco, Calif., USA (“dot_” substituted for “.” to avoid inclusion of browser-executable code)) model of standardized web-based catalogue-style applications.

Most large enterprises have a huge number of existing IT-supported business applications. These applications encode many specific ways of how the particular enterprise performs a given specific part of its business. They also typically come with significant amounts of data in formats specific to the business application. Furthermore, they may contain millions of lines of code.

### SUMMARY OF THE INVENTION

Principles of the invention provide techniques for discovery-based identification and migration of easily cloudifiable applications. In one aspect, an exemplary method includes the steps of analyzing infrastructures of a plurality of existing applications of an entity to identify at least one of the infrastructures of the plurality of existing applications which includes existing substructures enabling replication of individual parts via an existing replication mechanism; and selecting the at least one of the infrastructures for migration to a cloud. The cloud includes at least one of an infrastructure as a service cloud and a platform as a service cloud. Further steps include migrating the existing substructures of the at least one of the infrastructures to the cloud, without application-level change; assembling a business agility component configured to control extending and shrinking resources of the cloud that are devoted to the at least one of the infrastructures; and extending and shrinking the resources of the cloud that are devoted to the at least one of the infrastructures, using the business agility component.

In another aspect, another exemplary method includes the step of obtaining a specification of at least one infrastructure of a plurality of infrastructures of a plurality of existing applications of an entity that is to be migrated to a cloud. The at least one infrastructure includes existing substructures enabling replication of individual parts via an existing replication mechanism. An additional step includes identifying, in an application resource manager template store, at least one generic template including instructions for carrying out at least one of extending and shrinking resources of the cloud that are to be devoted to the at least one infrastructure. Further steps include instantiating a particular instance of the at least one generic template by populating the at least one generic template with specific data pertaining to the at least one infrastructure; and assembling, from at least the particular instance, a business agility component configured to control the at least one of extending and shrinking the resources of the cloud that are devoted to the at least one infrastructure.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer product including a computer readable storage medium with computer usable program code for performing the method steps indicated. Furthermore, one or more embodiments of the invention or elements thereof can be implemented in the form of a system (or apparatus) including a memory, and at least one processor that is coupled to the memory and operative to perform exemplary method steps. Yet further, in another aspect, one or more embodiments of the invention or elements thereof can be implemented in the form of means for carrying out one or more of the method steps described herein: the means can include (i) hardware module(s), (ii) software module(s), or (iii) a combination of hardware and software modules; any of (i)-(iii) implement the specific techniques set forth herein, and the software modules are stored in a computer-readable storage medium (or multiple such media).

Techniques of the present invention can provide substantial beneficial technical effects. For example, one or more embodiments may provide one or more of the following advantages:
more efficient management
shorter setup times when requirements on an application and its underlying IT infrastructure change
greater reliability
avoid wasting power with underutilized processors as the amount of resources can be easily increased and/or decreased
achieve the above-mentioned advantages more quickly
automation of the choice as to where it is worthwhile to code an application resource manager

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 depicts a cloud computing node according to an embodiment of the present invention;

FIG. 2 depicts a cloud computing environment according to an embodiment of the present invention;

FIG. 3 depicts abstraction model layers according to an embodiment of the present invention;

FIG. 4 is an overview system block diagram, according to an aspect of the invention;

FIG. 5 is a detailed system block diagram, according to an aspect of the invention;

FIG. 6 presents exemplary components of an application resource manager, according to an aspect of the invention;

FIG. 7 presents an exemplary flow chart, according to an aspect of the invention;

FIG. 8 presents an exemplary application “cloudification” scenario, according to an aspect of the invention; and

FIG. 9 is an exemplary software architecture diagram, according to an aspect of the invention.

### DETAILED DESCRIPTION OF PREFERRED EMBODIMENTS

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g. cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

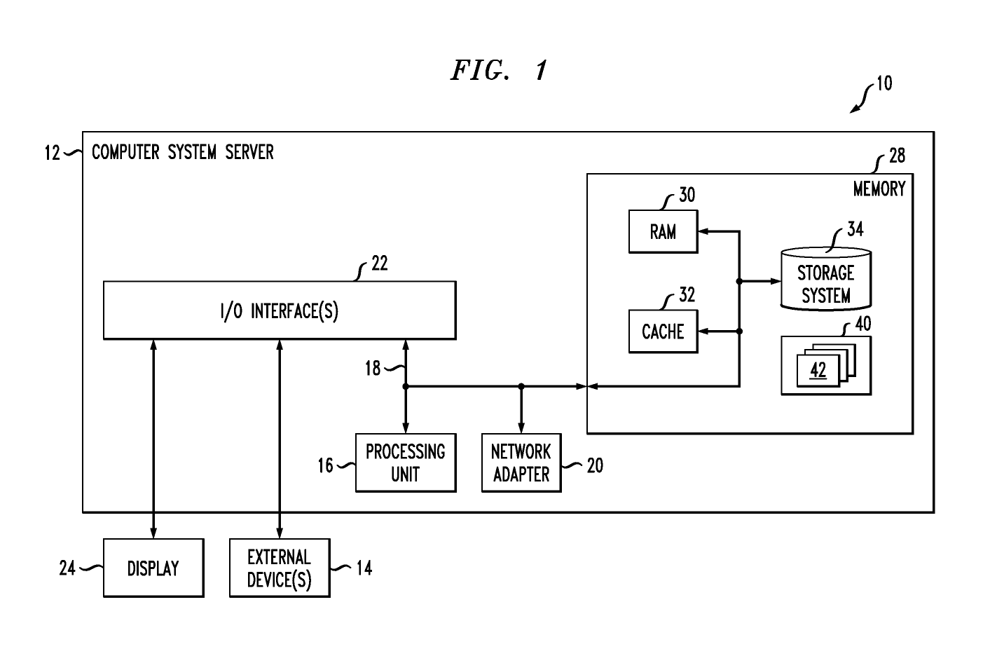

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth herein.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus. Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

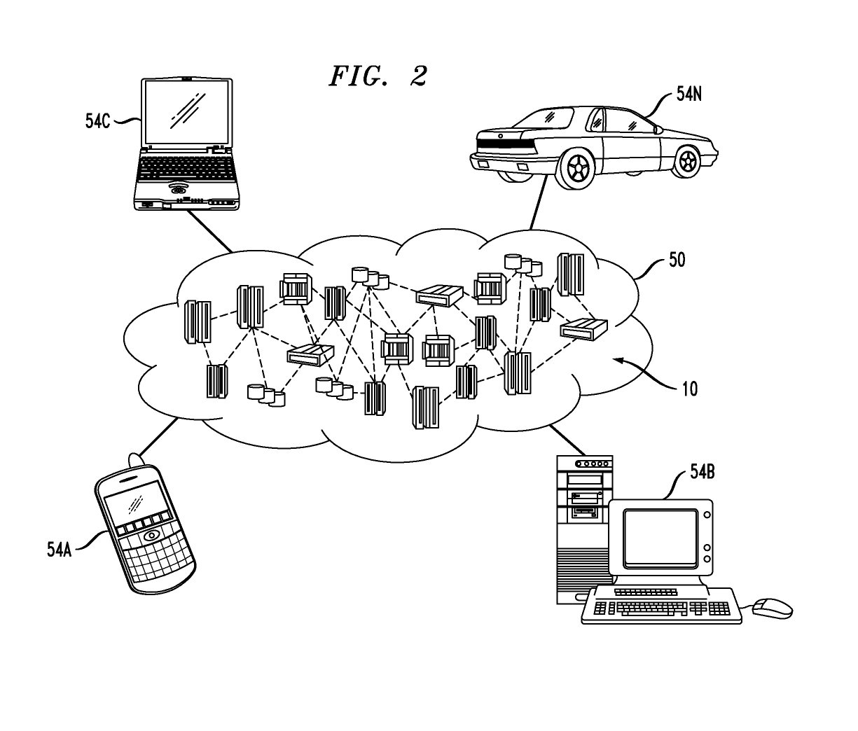

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

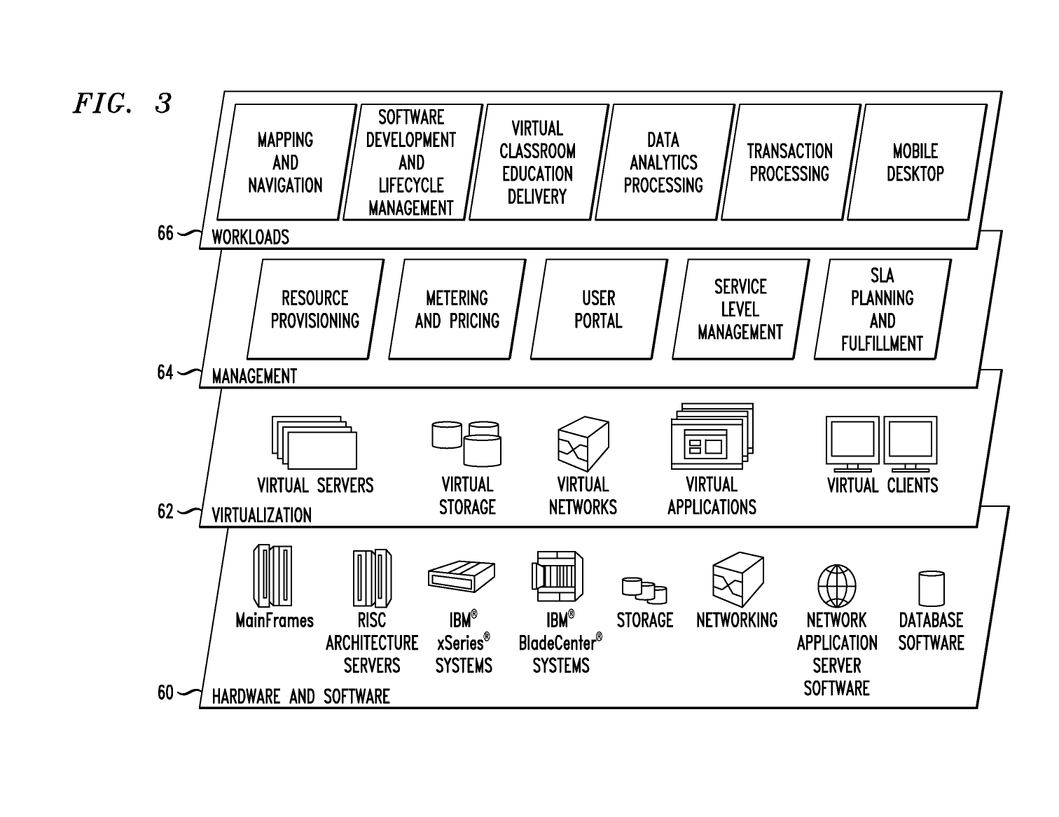

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and mobile desktop.

One or more embodiments advantageously implement an application resource manager over a cloud, such as, for example, an IaaS or PaaS cloud.

As noted above, Information-as-a-Service (IaaS) and Platform-as-a-Service (PaaS) clouds offer basic capabilities for fast deployment (provisioning) of images, stashing images away while they are not used, and potentially live or quasi-live changes to the resources assigned to images. However, this does not directly apply to the application layer (referred to herein interchangeably as workload layer 66), i.e. on the application layer 66 there are still humans needed to watch the utilization and to decide when and how it is possible to extend or shrink the infrastructure for an application. Exceptions are applications that are only deployed for a relatively short time and then completely dismantled like development and test applications. Indeed, these are by far the most common applications currently considered for running on IaaS and PaaS clouds.

Note that the virtualization and management layers 62 and 64 in IaaS and PaaS clouds manage only the hardware and possibly basic software, while they do not manage the workloads. Accordingly, heretofore this has been done separately and typically with human intervention.

As also noted above, Software-as-a-Service (SaaS) clouds work on the application layer, but are built very specifically for certain application types, such as the IBM LotusLive solution (trademark of International Business Machines Corporation, Armonk, N.Y., USA) or those available from Salesforce_dot_com, Inc., of San Francisco, Calif., USA (“_dot_” substituted for “.” to avoid inclusion of browser-executable code).

Again, as noted above, there are also high-level clouds that require applications to be coded in specific new programming models and languages, such as Amazon Web Services (mark of Amazon Web Services LLC, Seattle, Wash., USA), Microsoft Azure (mark of Microsoft Corporation, Redmond, Wash., USA), and Hadoop (available from the Apache Software Foundation).

One or more embodiments advantageously enable normal, largely unchanged applications with fluctuating or just increasing resource demand to easily make use of IaaS or PaaS platform capabilities.

It is worth noting that there has also been prior work with respect to dynamic infrastructure in the context of grids, but grids do not have the same kind of interfaces for provisioning and managing images as IaaS and PaaS clouds have, and hence the application management problem for grids is different from clouds. Similarly, older large distributed infrastructure projects such as IBM's Oceano computing utility powerplant project did not work with underlying separate layers 60, 62, 64 as in a cloud.

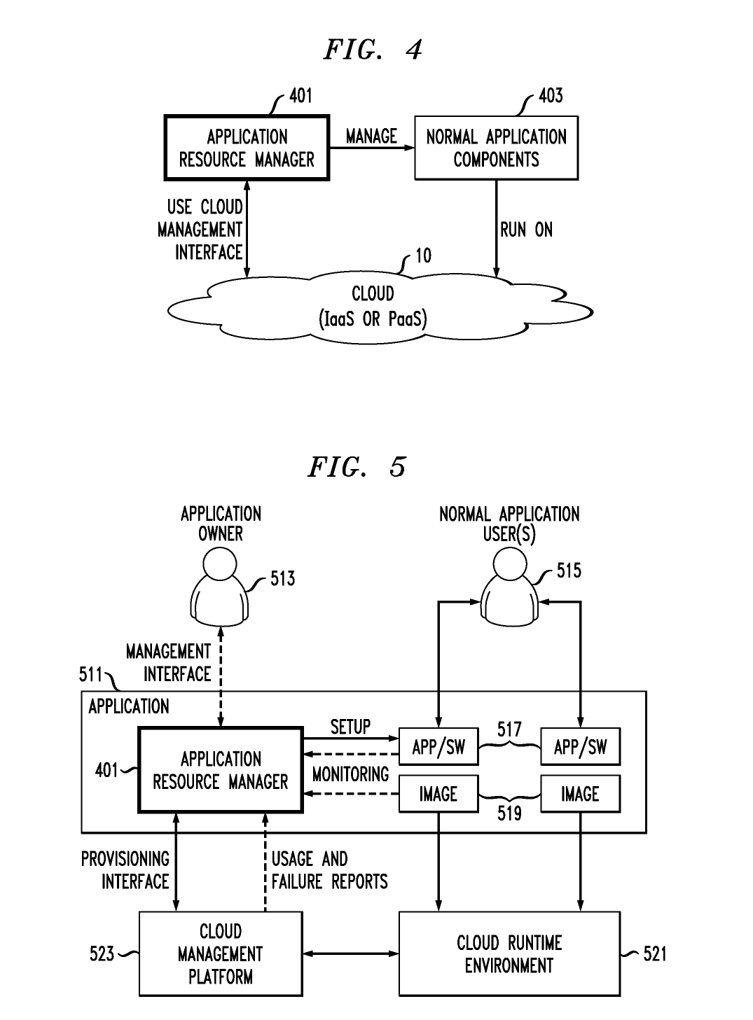

Referring now to the simple system overview of FIG. 4, one or more embodiments employ an application resource manager component 401 that is added to the normal system of IaaS or PaaS cloud 10 and application components 403. This application resource manager extends and shrinks cloud resources according to the application needs.

In order to carry out these tasks, the application resource manager interacts with the management interface of the underlying IaaS or PaaS cloud, i.e., the upper interface of the management layer 64, while the application uses images and other resources provided by the cloud. Here the word “images” is used for both for the pure operating-system images that an IaaS cloud offers and the images including middleware that a PaaS cloud offers. In terms of FIG. 3, IaaS images are virtual servers, and there is typically a catalogue of available, easy to provision images, image files corresponding to this catalogue, and actual instance images that have been provisioned and are running. The resource provisioning component of the management layer 64 offers the catalogue to the potential workloads of layer 66, contains the image files, and causes the establishment of instance images (virtual servers) in the virtualization layer 62. We will sometimes only talk of “images” when this process is understood. On top of the images provisioned to an application, there are the code, data, configurations, and the like of the normal application components. In other words, the part(s) of the workload that were not provisioned via the cloud management layer make up the application components.

The management interfaces that the application resource manager uses may contain OSS aspects (operations support system, e.g., a direct interface to a resource provisioning components) and BSS aspects (business support services, e.g., an interface to the pricing component if additional payment agreement is needed at the time of additional provisioning). All these may be filtered through the user portal, but we assume here that either this also contains an API (application programming interface), web service interface etc. for use by automated programs from the Workloads layer 66, or interfaces to the individual components such as Resource Provisioning are directly accessible to the programs of the Workloads layer 66.

The application resource manager 401 may learn upcoming demand from an application owner 513 (name used herein for a human authorized to predict application demand, to distinguish this role from normal users 515—see FIG. 5), or may derive current utilization and trends from reports obtained from the cloud management as well as by observing the application. The application resource manager 401 may also learn about infrastructure failures, and react on them to reach certain availability targets.

Given demand changes, at a minimum, in at least some embodiments, the application resource manager provisions or stashes images or changes their resource attribution, such as virtual storage or assignment of virtual network bandwidth. Optionally, in the case of provisioning, it also provisions application-level software and/or data onto the new images.

Thus, one or more embodiments provide a system including a cloud 10, at least one application component 403, and an application resource manager 401, wherein the application resource manager extends and/or shrinks cloud resources for the application component in order to meet application resource needs.

The application resource manager, in one or more embodiments, uses the services of an IaaS or PaaS cloud. More details about these components and their interactions are shown in FIG. 5, which provides a more detailed system overview.

It should be noted that the application resource manager 401 may or may not itself run on the cloud 10. The application box 511 is virtual; it indicates that the application resource manager belongs to a specific application and should be aware of the application structure.

With continued reference to FIG. 5, application owner 513 interacts with application resource manager 401 via the application management interface (In FIG. 3 this is the upper interface of the Workloads layer 66, i.e., where the applications/workloads interact with their users). Application resource manager 401 is associated with application 511 and carries out setup of application software 517 used by normal application users 515, as well as monitoring of the application software 517 and corresponding images 519. The images become part of cloud runtime environment 521. Block 521 is essentially analogous to the virtualization layer 62 from FIG. 3 (or layers 60 and 62 together), while cloud management platform 523 is analogous to layer 64. Cloud management platform 523 manages cloud runtime environment 521 which interacts with application resource manager 401 via a suitable provisioning interface (i.e., an interface to the resource provisioning component, either directly or intermediated through a BSS interface and/or the user portal), and cloud management platform 523 also provides usage and failure reports to application resource manager 401 (these could come, e.g., from the metering component or the Service Level Management component of FIG. 3).

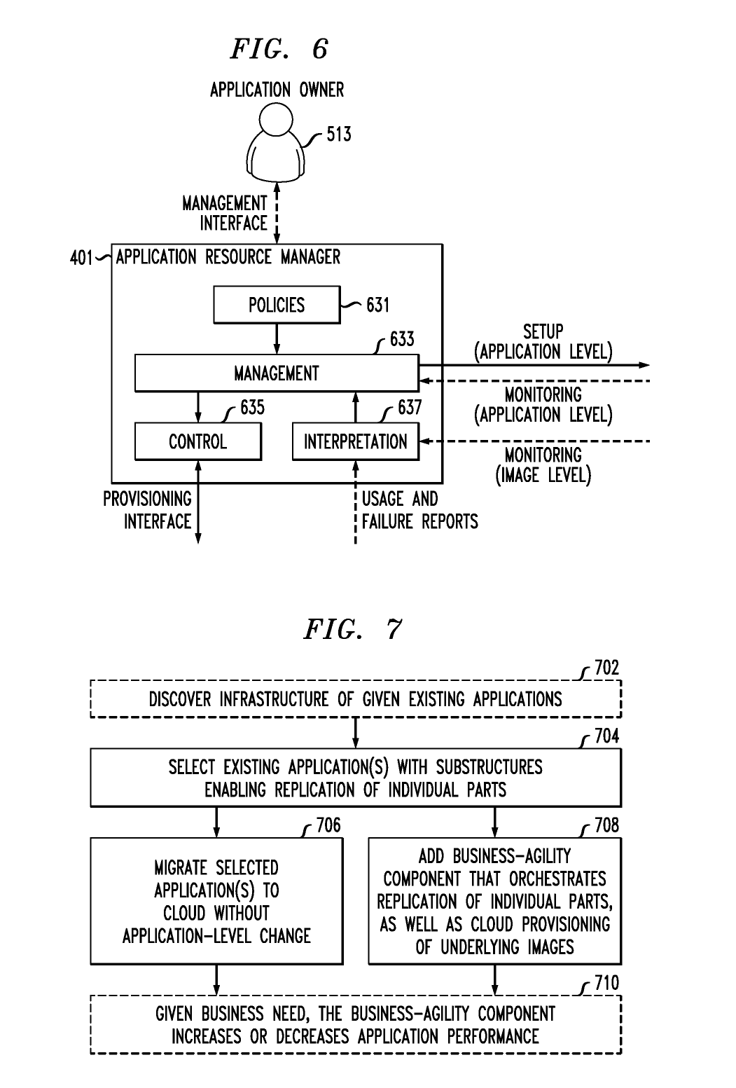

In one or more embodiments, an application resource manager such as 401 may be structured as shown in FIG. 6, wherein the components provide the following exemplary functions:

Policies 631 determine long-term goals, e.g., performance and availability goals that might be given as service-level objectives of the application (in contrast to those of the cloud); in other words these are objectives for Layer 66, not for Layer 64 as the Service Level Management component and SLA planning component of that layer fulfill). Shorter-term objectives from an application owner, such as those relating to a near-term prediction for increased performance needs, may also be phrased as policies.

Management component 633 takes the policies as well as what it learns from the application and the cloud and determines actions. These actions in particular include provisioning, stashing, or de-provisioning requests to the cloud, and whatever other actions the cloud management platform allows. e.g., growing and shrinking of image resources, live migration to different servers, or selection of a higher service level from the cloud (which may, e.g., include better performance guarantees as well as higher availability or reliability guarantees).

The control component 635 translates abstract requests from the management component into concrete interactions with the cloud management platform, e.g. via an application programming interface (API) or a web services interface. Such an interaction may be a multi-step sequence, and might include OSS and BSS level steps, such as choosing an image size and selecting a payment method or existing account number.

The interpretation component 637, conversely to the control component, interprets reports from the cloud, such as utilization information about both the application's own images and other virtual resources and the overall cloud, or failure reports.

A benefit of breaking out a control component and an interpretation component from the management component is that the application resource manager becomes easier to adapt to different clouds. In the example in FIG. 6, the application resource manager is allowed to directly interact with the application components, though, because it is specific to this application.

Additional non-limiting exemplary details will now be provided with respect to some possible functions of the application manager.

With respect to monitoring, in some instances, the application manager may monitor the application components 403 and their utilization, either or both at the user interfaces of the application (where, e.g. an application service-level agreement (SLA) may apply), and for individual components (such as 517, 519); in particular those deployed on different images. The application manager may also obtain information about the current usage of its cloud images via the cloud interface (i.e., from 523), and/or may obtain information about the current overall usage of the cloud via the cloud interface—this may be interesting to predict the effect of obtaining more resources, if the resources are shared.

Furthermore, also with respect to monitoring, in some instances, the application manager may obtain information about failures of its own images (from 523), and general reliability of the cloud; may use prediction, based on utilization trends, to estimate future demand (e.g. predicting monthly peaks, or predicting an overall slow rise in demand); and/or may, from time to time, revalidate the application structure by discovery tools (discussed further elsewhere herein and referred to interchangeably as “rediscovery”). Those would be applied to the application's images 519 and application software 517, as the users 515 of the application may also have certain rights to make changes. Discovery tools may also help to find application-level performance parameters such as current database sizes.

With respect to goals, in some instances, the application manager may obtain short-term goals, either absolute or relative to current performance, from the application owner. These goals typically refer to the application as a whole (e.g., transaction throughput or response time to end users), rather than to the performance of individual application software components on the individual images. Furthermore, the application manager may obtain high-level goals (long-term policies) from the application owner. e.g., to always provide certain SLAs, or to always have a certain amount of headroom for sudden changes; and/or it may obtain cost goals or limits, e.g. to always choose the cheapest overall set of resources to provide a desired SLA, or to always offer best possible performance but only up to a certain cost limit.

With respect to possible decisions, in some instances, the application manager may decide to extend and/or shrink the resources assigned to individual cloud images assigned to the application. Depending on the cloud this might be done in place, or by migrating the corresponding application component 517 to a bigger image 519. In addition, the application manager may decide to provision, delete, or stash away entire cloud images for the use of the application. In this case, it also should deploy appropriate application software on them. In this regard, the application manager may retain one or more gold images for this purpose, i.e., dormant images that already contain all repeatable parts of the application; and/or may also use migration tools to deploy software configurations corresponding to the current overall application status.

Furthermore, also with respect to possible decisions, in some instances, the application manager may decide to ask for additional storage and/or network resources, if the cloud offers such choices separately; may decide to alarm the user if it cannot fulfill its current policies or requests; and/or may inform the user of the application-level situation on a regular basis or upon request.

With respect to decision-making, in some instances, the application manager may make decisions by employing an optimizing solver tool, or it may contain the decision-making code directly. It may make decisions based on dynamic cloud costs, if the cloud has a dynamic pricing schema (e.g., lower cost on weekends). Using dynamic cloud costs is particularly useful if the application contains aspects that are not time-critical and can be performed in times of cheaper resources.

It should be noted that policies can, in at least some instances, be implemented by parameters in a data file or the like wherein allowable values and other variables can be specified without having to change the underlying coding; that is, a data structure specifying allowable values or ranges of values.

With regard to policies block 631, in one or more instances, the same determines goals or requirements, or sometimes what should happen in a specific situation. In particular, it may contain policies (i.e., formalized goals or requirements) on the application level, for example, what latency for application-level transactions is acceptable, how close to deadlines one might get with how many long-running jobs still unfulfilled, or how much load to expect, e.g., at month end. It may sometimes also contain infrastructure-level policies, e.g., what amount of free storage should always be available, what level of usage a virtual machine (VM) should be permitted to have for a sustained period of time, and so on.

Management block 633 includes logic which reads the values from the policies 631 and obtains data input about what is happening in the system (say, from a probe or the like at the application level, as well as, the interpretation block 637, from cloud reports or image-level monitoring), and puts policies 631 into action. Examples include determining that VMs should be allocated, stashed or services started on other VMs; determining if a VM's memory and/or CPU allocation should be increased; determining if storage should be increased and/or decreased; and the like.

Control block 635 provides an interface to different architectures; for example, if the cloud were simply vmware, it would interact with a vmrun interface to control the VMs. That is, control module 635 translates instructions from management module 633 so they can be understood by a resource provisioning module (see layer 64 in FIG. 3) or the like which is managing the cloud resources.

With regard to interpretation block 637, the same provides an interface to different cloud architectures; for example, if the cloud were simply VMware, it might interpret performance reports from vmware interfaces; and/or an abstraction to probes able to run inside VMs. In some instances, the cloud may provide CPU utilization of images (see, e.g. metering and pricing in layer 64 in FIG. 3). Management block 633 will advise interpretation block 637 that it needs the CPU utilization of all the images, block 637 will translate this and give the required command to the metering and pricing block, and interpret the cloud-specific results into a common format. In some instances, ARM 401 makes a connection to the images it manages on its own layer, in addition to or in lieu of the cloud interface, e.g., to monitor application-level latency (i.e., how long normal application users 515 have to wait for results) or to learn about the status of long-running applications. In such cases, an IP listening service or web interface for management may be provided by application software 517, and the application manager builds up corresponding connections and sends corresponding management queries.

In some instances, the ARM 401 has an account on the normal image and can use same to log into the normal image and execute a suitable command to read out the CPU utilization directly from the image. In some cases, the application may be programmed to respond to suitable queries, such as how many transactions have been executed in the last 10 minutes.

For the avoidance of doubt, the “application” in this context refers to the code that carries out the ultimate desired function (and has not been provided by the cloud), say, JAVA code within WEBSPHERE software, or a particular database schema within DB2 software, or typically a combination of such types of code, e.g., all code pieces needed to provide a shopping cart application or a travel reporting application. The probes are pieces of software that communicate with other software to obtain desired values, as opposed to physical probes like thermocouples.

By way of a detailed but non-limiting example, consider a three-tier architecture, with a (typically more than one) Web Server, Application Server, and Database. It is desired to keep the average latency for the end-user requests under a specific threshold. Latency can be caused by any of the elements being overloaded. It is desired to measure latency to respond to requests (application specific—example—how long it takes an http server to respond to a request).

In this example, policy block 631 defines what latency should be available for responding to incoming requests and possibly what the regular state of the system should be. Interpretation block 637 interfaces with probes that provide information about individual components. Management block 633, using policy block 631 and data from interpretation bock 637 as well as direct communication with application software, makes decisions, such as to increase the number of VMs handling incoming requests to lower latency if it is too high, possibly deciding which of the 3 tiers is a bottleneck and needs to be increased. Management block 633 interfaces with control block 635 to instruct the cloud to clone an existing master template VM and bring it on-line, and is then responsible for putting appropriate data on it and binding it into the application so that it can take its share of the load.

Conversely, if latency is far below bounds and there are more than the normal steady state number of VMs (per policy 631), management 633 may instruct control 635 to shut down VMs slowly, and it is responsible for resetting the application so that all workload gets handled by the remaining VMs, e.g., by modifying an application-level load balancer policy.

By way of further detail on this non-limiting example, policy 631 defines what latency should be available for responding to incoming requests and what the regular state of the system should be:

average_latency {

period = 1min
max_latency = 500ms

}

This sets a policy that the average latency over a one minute period should not be above 500 ms. Typically, if that were starting to happen, more machines should be allocated. As discussed above, logic in the management module 633 obtains data from the probe, examines the policies 631, and takes appropriate action if any policies are violated; instructions to effectuate same are sent to control block 635 where they are translated as also described above.

Management block 633 can also run micro-tests against each individual application software component 517.

Management block 633 then optionally puts into practice logic to try to determine what layer is causing the latency. It has the ability to perform micro-benchmarks on each layer, which does not impact any other layer. For example, it can fetch a static webpage off the web server to measure just the web server's latency. It can do a simple query against the app server that doesn't hit the database, as well as simple database queries. These enable it to pinpoint which component is overloaded, along with the VM level measurements provided by interpretation block 637, and therefore which component needs to be increased in size. In this regard, note that measurements can be used alone, micro-benchmarks can be used alone, or both can be used together. Furthermore, micro-benchmarks can be based, for example, on a pre-test on a well-running system to know desired values.

If, for instance, management block 633 determines that the web server front end is overloaded and the best decision is to add more front ends, it will instruct control block 635 to allocate a new VM, and will then put any necessary additional software and application data on it and integrate it into the application.

If a cloud were just VMware, control block 635 will copy a gold master VM of the web server front end to a new VM. It will then use the VMware API's RegisterVm( ) functionality to add the VM to the VM infrastructure. Once added, control block 635 will use the API to connect to the new VM and use its Start( )method to boot the machines. Management block 633 will then add it to the cluster of machines handling front end duty. In a simpler example, the size of a machine could be increased.

In another non-limiting example, consider monitoring storage usage. Policy 631 defines what amount of free storage should be available as well as what is too much free storage. Interpretation block 637 interfaces with normal interfaces (du, df, quota, . . . ) to determine the amount of free space. Management block 633 uses both of these pieces of information to determine if not enough free space (or too much) is available. Management block 633 instructs control block 635 to allocate more free space (or reduce) as per policy. A suitable command might be of the form “increase-disk <image id> <disk id> <size>”.

For example, some VMs might be able to run one or more services, depending on the load of the VM. In some instances, it is then possible to monitor the VM load (from the VM infrastructure), and have probes in each VM to monitor the resource usage (CPU. I/O) of individual services to know how much each individual service is using.

Policy 631 may determine what sustained load a VM should be allowed to operate under and what sustained load the individual services running on the VM should be allowed. Interpretation block 637 interfaces with VM infrastructure load monitoring (overall VM load) and probes inside of VM (to monitor OS level load measurements for each individual service). Management block 633 can make decisions to split apart the VM so that individual services can run on independent VMs if the load on an individual VM is too high or combine them back together if load has decreased. It interfaces with control block 635 to start up new or shut down existing VMs as needed as well as to shut down or start services running on the individual VMs.

In still another non-limiting example, consider growing a VM's memory and CPU usage. Policy 631 determines what sustained memory and CPU load should be allowed on a single machine. Interpretation block 637 obtains reports of CPU usage and free memory and feeds this to management block 633. Management block 633 can decide to increase (or decrease) the CPU and memory allocation of an individual VM. It instructs control block 635 to do so. Control block 635 can shut down the VM (if needed, some VMs support hot-plugging CPUs), reconfigure it to increase the number of CPUs and the allocated memory, and restart it using the VM architecture's interfaces (ex: on vmware, vmrun; and editing the VM's configuration file manually or via APIs).

In an even further non-limiting example, consider a case where a permitted downtime per month is specified. The application manager may keep track of the total downtime thus far during the month; if it notices that the allowable limit is being approached, it will order additional resources using control component 635.

The following are non-limiting exemplary actual commands for provisioning a server and increasing storage:

provision <template/base id name> <new id name>>
increase-disk <id name> <size>

In another aspect, one or more embodiments address the migration of existing business applications to a cloud-style model, i.e., to IT infrastructures where business applications can easily grow and shrink according to business need. This is also called business agility, and typically associated with costs or pricing only according to the resources that a business application actually uses.

Thus, one or more embodiments provide discovery-based identification and migration of easily cloudifiable applications. As noted above, clouds are a currently topic of interest in industry. A current focus area is to design and implement new application programming models, and to build new applications according to these models. Examples are Google's map-reduce model (available from Google Inc. of Mountain View, Calif., USA) and Salesforce_dot_com's (Salesforce_dot_com, Inc., of San Francisco, Calif., USA (“_dot_” substituted for “.” to avoid inclusion of browser-executable code)) model of standardized web-based catalogue-style applications.

While these efforts are suitable for a range of new applications, most large enterprises have a huge number of existing IT-supported business applications. These applications encode many specific ways of how the particular enterprise performs a given specific part of its business. They also typically come with significant amounts of data in formats specific to the business application. Furthermore, they may contain millions of lines of code. For these reasons, it is very rare that an enterprise can afford to have such an application completely rewritten in a new programming model. Even more moderate changes, such as taking the application apart into modules interacting via web services, or re-implementing the data formats, are very costly and often risky, so that most enterprises would not do this for most of their applications.

The aforementioned new application programming models may be of limited utility in cases where there is a large amount of existing code; advantageously, one or more embodiments of the invention address such cases and allow cloudification even when there is a large amount of existing code.

Indeed, enterprises would like to make use of the promises of clouds, in particular of the business agility. One reason is on the business level; fast business growth in unexpected areas is only possible with this agility. Another reason is cost saving; Even if one can predict or guess future demand, as long as the infrastructure is relatively static, one has to grow the infrastructure well in advance, and will probably not reduce it again after a peak. This wastes resources.

One current or near-future option is to migrate to an infrastructure-as-a-service (IaaS) cloud, such as the Amazon Elastic Compute Cloud (Amazon EC2) web service or the IBM SmartCloud Enterprise available from International Business Machines Corporation, Armonk, N.Y., USA. An IaaS cloud enables fast provisioning of operating-system images. This is a good foundation. However, it is not yet business agility, because a lot of extra work is still needed to make these empty operating-system images useful for the specific business application. It is believed that there is not any current method of doing this systematically for any existing applications.

With reference to FIG. 7, one or more embodiments handle existing applications as follows. In step 702, typically, an infrastructure discovery tool is run in order to obtain enough information for the following steps. Preferably this tool should be able to trace business applications, e.g., like IBM Research's Galapagos tool (see, e.g., K. Magoutis, M. Devarakonda, N. Joukov, and N. G. Vogl, Galapagos: Model driven discovery of end-to-end application-storage relationships in distributed systems, IBM J. RES. & DEV. VOL. 52 NO. 4/5 Jul./Sep. 2008, 367-377).

The following co-assigned US Patent Publications will be of interest to the skilled artisan in connection with discovery and/or migration, and are all expressly incorporated herein by reference in their entireties for all purposes:
20110196984 DISTRIBUTED PARALLEL DISCOVERY
20110196959 MIDDLEWARE-DRIVEN SERVER DISCOVERY
20110191454 DISCOVERING PHYSICAL SERVER LOCATION BY CORRELATING EXTERNAL AND INTERNAL SERVER INFORMATION
20110107327 ASSISTING SERVER MIGRATION
20110055816 METHOD TO DERIVE SOFTWARE USE AND SOFTWARE DATA OBJECT USE CHARACTERISTICS BY ANALYZING ATTRIBUTES OF RELATED FILES
20110055806 METHOD AND SYSTEM TO DISCOVER POSSIBLE PROGRAM VARIABLE VALUES BY CONNECTING PROGRAM VALUE EXTRACTION WITH EXTERNAL DATA SOURCES
20110029946 EFFICIENT EXTRACTION OF SOFTWARE DEPENDENCIES FROM PROGRAM CODE
20100319060 PROCESS AND SYSTEM FOR COMPREHENSIVE IT DISCOVERY WITHOUT CREDENTIALS
20090307743 METHOD TO AUTOMATICALLY MAP BUSINESS FUNCTION LEVEL POLICIES TO IT MANAGEMENT POLICIES
20090307174 CONNECTION OF VALUE NETWORKS WITH INFORMATION TECHNOLOGY INFRASTRUCTURE AND DATA VIA APPLICATIONS AND SUPPORT PERSONNEL
20090150472 METHOD FOR NON-DISRUPTIVELY ASSOCIATING APPLICATIONS AND MIDDLEWARE COMPONENTS WITH INFORMATION TECHNOLOGY INFRASTRUCTURE
20110213883 SYSTEM AND METHOD FOR OBJECT MIGRATION USING WAVES

An additional step includes analyzing the infrastructure belonging to each business application for existing substructures that enable replication of individual parts, and selecting one or more business applications of this type, as in step 704. In step 706, migrate the individual substructures of the application to an IaaS cloud without application-level change. In step 708, assemble a business-agility component that can perform one or more, and preferably all, of the following tasks:
To understand changes in business need, it either takes inputs about business-level growth or shrinkage demand, or it analyzes whether the current business performance is getting close to certain upper or lower bounds.
Correspondingly it increases or shrinks the substructures. To carry this aspect out, the component uses:
   the identified existing replication mechanism to extend or shrink the substructures; and
   the IaaS cloud infrastructure to provision, de-provision, or stash/restore the necessary operating system images.

In step 710, the business-agility component indeed performs the tasks for which it was assembled in Step 708.

One suitable business agility component is the above-discussed application resource manager. Reference is made to co-assigned, co-pending U.S. patent application Ser. No. 13/180,858 of Murthy V. Devarakonda et al, entitled Application Resource Manager over a Cloud, filed on 12 Jul. 2011, and expressly incorporated herein by reference in its entirety for all purposes.

Note that one or more embodiments do not necessarily handle all applications. It is believed that taking an arbitrary application of unknown, complex structure and implementing business agility for it with moderate effort may not be practical at present. Instead, one or more embodiments identify business applications where introducing business agility is possible soon and with moderate overhead, and enable actual migration of these business applications. This leads to near-term business agility improvements and cost savings that would otherwise not be possible.

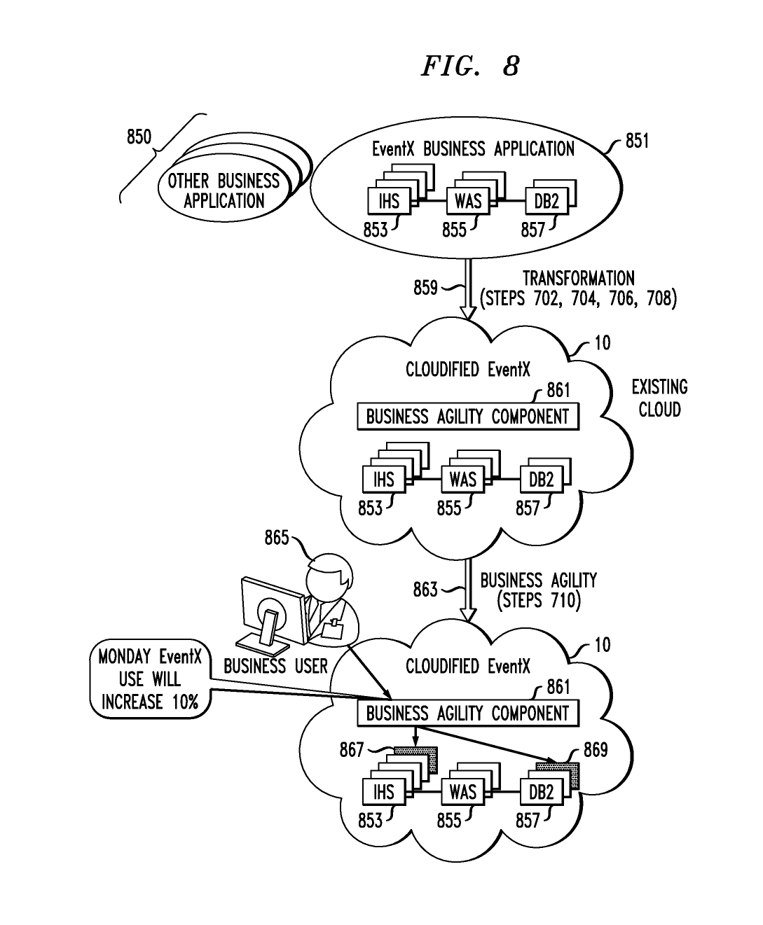

An example illustrating the method of FIG. 7 is given in FIG. 8. In this example, the initial discovery (Step 702) showed up a business application 851, called “EventX,” including a web server cluster 853 (illustrated as multiple IBM HTTP Servers, IHS), an application-server cluster 855 (illustrated as multiple IBM WebSphere Application Servers. WAS), and a database cluster 857 (illustrated as multiple DB2 databases). Other applications not suitable for “cloudification” are at 850. Web servers, application servers, and databases, and the specific examples thereof, are exemplary and non-limiting.

Thus this business application will survive the selection in step 704, as it includes substructures that enable replication of individual parts—each of the three clusters is such a substructure, and the individual IHS, WAS, and DB2 elements are the parts.

The transformation arrow 859 corresponds to steps 702, 704, 706, 708, and primarily to steps 706, 708. On the one hand, the existing substructures of the business application “EventX” are migrated to the cloud 10 essentially unchanged, i.e., their code and middleware-level settings remain as before. (Slight changes such as version upgrades may be performed for other reasons during the cloud-migration and do not affect this method.) On the other hand, the business agility component 861 is introduced.

The business agility arrow 863 corresponds to step 710. At some later time, there is a need to grow or shrink the business application. The example in the figure is of a business user 865 who predicts (on the business level) that the use of EventX will increase by 10 percent on the next Monday. In this case, we see that the business-agility component 861 decided to add one new IHS server 867 to the web server cluster and one new DB2 869 to the database cluster. The exact mechanism that the business-agility component uses for these decisions may vary in different embodiments; there may even be some additional manual advice. Again, as noted, in a preferred but non-limiting approach, the above-discussed application resource manager 401 is used as the business agility component.

In one or more embodiments, there will not only be new images on the underlying IaaS cloud 10, and not even only new images 867, 869 with an IHS 853 and a DB2 857, but even further, these middleware parts are fully integrated into their respective clusters at the end of step 710 and ready to take part in fulfilling the increased business needs.

An example of a business application EventX where a business user may be able to predict such a usage increase is a sports event that will begin on Monday. Another example is a sales application whose use is predicted to increase due to a new marketing campaign, or due to a seasonal change.

The method is not restricted to clusters as the underlying structures; any other existing method of replicating individual parts of substructures may be used.

In some cases, step 710 may be improved by monitoring, i.e., if the business-agility component 861 keeps track of, or can have discovered, how the individual substructures perform at any time, so as to increase or shrink only those that need it. If there are no measurements, there may also be performance predictions, e.g., from the design phase or an earlier tuning phase, that link the performance of substructures with the performance of the application as a whole. For example, in FIG. 8, the business-agility component knows from one of these sources that to increase the business-level performance by 10° A given the current state of the systems, it needs to add one IHS and one DB2, but not a WAS.

One or more embodiments may with small changes also be realized on a platform-as-a-service (PaaS) cloud instead of an IaaS cloud. For instance, a PaaS cloud may offer preconfigured IHS. WAS, and DB2 components. In that case, the example above can proceed quite similar to above, except that now new images are not built by first installing an empty OS using the IaaS interfaces, followed by setting up cluster components on them, but rather by provisioning images that already include the base software. The business agility component still has to replicate the business-application-specific elements such as web pages, code, or data onto these images, and to link them into the business application flow and the potential management software of the substructures.

Thus, one or more embodiments build a business-level agile application by migration. In one or more embodiments, using, for example, an augmented discovery tool analyze workloads in detail; and identify some with a standard clustered tier structure, such as, in particular IHS-WAS-DB2 or similar workloads. One or more embodiments advantageously achieve business-level scalability by fast deployment of additional cluster elements. In some cases, utilization data may help in seeing bottlenecks and identifying which clusters need extending when demand rises, and by how much.

It is presently believed that a business-level extension request should bring up new images in the cloud, with cluster software on them (e.g., additional IHS or DB2), and with the application software inside that cluster (e.g., EventX web serving), and further, should link that in with the cluster managers so that it all runs immediately.

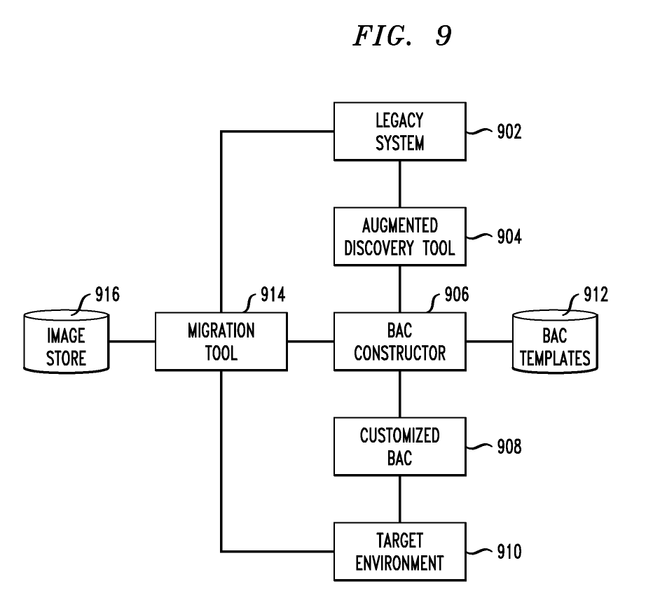

FIG. 9 is an exemplary software architecture diagram, according to an aspect of the invention. As seen therein, augmented discovery tool 904 performs discovery on legacy system (also known as source environment) 902 to identify at least one easily cloudifiable application. Migration tool 914 takes input from legacy system 902 and augmented discovery tool 914 and carries out migration of the easily cloudifiable application to the target environment (cloud) 910. Migration tool 914 optionally employs image store 916. Meanwhile, business agility component (BAC) constructor module 906 (also known as an automatic code generation module) generates a customized BAC 908 to manage the easily cloudifiable application once it is migrated to the target environment 910. BAC constructor module 906 makes use, for example, of a data store with BAC templates 912. See FIGS. 4-6 and accompanying text for discussion of an exemplary ARM 401, which is one preferred but non-limiting form of BAC.

Given the discussion thus far, it will be appreciated that, in general terms, an exemplary method, according to an aspect of the invention, includes the step 702 of analyzing infrastructures of a plurality of existing applications of an entity to identify at least one of the infrastructures of the plurality of existing applications which includes existing substructures enabling replication of individual parts via an existing replication mechanism. A further step 704 includes selecting the identified infrastructure(s) for migration to a cloud. The cloud is an infrastructure as a service cloud and/or a platform as a service cloud. A still further step 706 includes migrating the existing substructures of the identified infrastructure(s) to the cloud, without application-level change. Additional step 708 includes assembling a business agility component configured to control extending and shrinking those resources of the cloud that are devoted to the identified infrastructure(s). Step 710 includes extending and shrinking the resources of the cloud that are devoted to the identified infrastructure(s), using the business agility component. As noted, an example of the business agility component 861 is the application resource manager 401.

As noted elsewhere, in some instances, an additional step includes running an infrastructure discovery tool, such as the IBM Research GALAPAGOS tool, to obtain information for the analyzing step.

As also noted elsewhere, clusters are a non-limiting example of substructures. In turn, web server clusters, application server clusters, and database clusters are non-limiting examples of clusters.

In some instances, the business agility component assembled in the assembling step is further configured to assess changes in need which will drive the extending and shrinking of those resources of the cloud that are devoted to the identified infrastructure(s). An additional step in such cases can include assessing the changes in need: for example, by accepting input regarding at least one of demand growth and demand shrinkage and/or analyzing whether demand is approaching at least one of an upper bound and a lower bound.

As noted, in some cases, the cloud is an infrastructure as a service cloud. In such cases, the extending and shrinking of resources includes extending and shrinking using the existing replication mechanism while using the infrastructure of the infrastructure as a service cloud to carry out provisioning, de-provisioning, stashing, and/or restoring corresponding operating system images.

As noted, in some cases, the cloud is a platform as a service cloud. In such cases, the extending and shrinking of the resources includes at least extending by provisioning, on the platform as a service cloud, images including base software associated with the substructures (e.g., base software is IHS 853 in the cluster of IHS 853, WAS 855, and DB2 857). In a PaaS cloud, there will be images that already contain IHS, so the extension involves the ARM asking for a new virtual machine with an IHS already on it. In the case of an IaaS cloud, the extension involves the ARM asking for a new virtual machine, and the ARM places the IHS on the new virtual machine.

In one or more embodiments, the extending and shrinking of those resources of the cloud that are devoted to the identified infrastructure(s), using the business agility component, is carried out at the level of the substructures. In some cases, carrying out extending and shrinking at the level of the substructures is based on performance monitoring of the substructures. That is, as noted, in some cases, the business-agility component 861 keeps track of, or can have discovered, how the individual substructures perform at any time, so as to increase or shrink only those that need it.

In some cases, carrying out extending and shrinking at the level of the substructures is based on performance predictions for the substructures. That is, as noted, if there are no measurements, there may also be performance predictions, e.g., from the design phase or an earlier tuning phase, that link the performance of substructures with the performance of the application as a whole. For example, in FIG. 8, the business-agility component knows from one of these sources that to increase the business-level performance by 10%, it needs to add one IHS and one DB2, but not a WAS.

In another aspect, another exemplary method includes the step of obtaining (e.g., by module 906 from tool 904, possibly with input from a human expert) a specification of at least one infrastructure of a plurality of infrastructures of a plurality of existing applications of an entity that is to be migrated to a cloud. The at least one infrastructure includes existing substructures enabling replication of individual parts via an existing replication mechanism. An additional step includes identifying (e.g., by module 906), in a BAC template store 912, at least one generic template including instructions for carrying out at least one of extending and shrinking resources of the cloud that are to be devoted to the at least one infrastructure. Further steps include instantiating (e.g., by module 906) a particular instance of the at least one generic template by populating the at least one generic template with specific data pertaining to the at least one infrastructure; and assembling (e.g., by module 906), from at least the particular instance, a business agility component 908 (e.g., customized BAC such as a customized ARM) configured to control the at least one of extending and shrinking the resources of the cloud that are devoted to the at least one infrastructure.

The method just described can be combined with the previously-discussed method, such that in the previously-discussed method, the assembling step includes: identifying, in a business agility component template store, at least one generic template including instructions for carrying out at least one of extending and shrinking resources of the cloud that are to be devoted to the at least one of the infrastructures; instantiating a particular instance of the at least one generic template by populating the at least one generic template with specific data pertaining to the at least one of the infrastructures; and assembling, from at least the particular instance, the business agility component.

With regard to the augmented discovery tool, consider the non-limiting example of an application server (e.g., WAS 855). In some instances, a commercially available discovery tool is augmented to recognize to discover a dedicated management node (e.g., server) with configurations different than the other WAS nodes. In this case, by determining that WAS is present on a server and by analyzing the configuration of the server, the augmented discovery tool determines that the particular server is a management node. Once it is determined that the particular server is a management node, by further analysis of the configuration, it can be seen that the management node is managing other servers in a clustered configuration. Such a WAS management node and the servers it manages is a good candidate for cloudification.

Consider also the non-limiting example of ORACLE (or other) database software (registered mark of Oracle International Corporation, Redwood City, Calif. 94065 USA). There might be, for example, a WAS application server 855 using ORACLE software. The WAS servers would interact with an ORACLE cluster. Here, the WAS server may not specifically be a management node but it will make database connections to a cluster of databases, which can be seen in its configuration files. This clustering again indicates a good candidate for cloudification.

Thus, in one or more embodiments, an existing discovery tool, such as the aforementioned GALAPAGOS tool, is enhanced to identify clustering, as in the preceding two examples. Given the teachings herein, the skilled artisan will be able to modify an existing discovery tool to examine, e.g., configuration files to identify clustering and the like so as to locate good candidates for cloudification.

Suppose, in the non-limiting example of a cluster of application servers with a management node, two servers and a management node were found and migrated, and it is now desired to increase the application server cluster by adding a third server (assume this was determined by the ARM). The ARM will need to copy a current application server to obtain a third one similar to the two existing ones; also, the management node must be updated to be made aware of the fact that there are now three servers instead of two. The copying is a fixed activity (assuming the web servers to be stateless). The management node could be updated, for example, via an API (application programming interface): a command could be sent to include a third web server into its cluster. Alternatively, the configuration file in which the discovery took place could be directly updated. For example, copy the configuration file, copy the name of the third web server into it, and re-write it as a configuration file for three web servers, and then write the re-written file back to the management node.

With respect to a database application, the databases, in themselves, must be aware that they replicate their content with each other; thus, some configuration of the databases to replicate with each other is present. Furthermore, the WAS nodes or the like will know about the cluster and thus the application servers will also need to be updated—initially, it is known that one of two databases can be used—updating is required to indicate that now, one of three databases can be used.

Operations such as those just described (use of API and/or changing of configuration files) are essentially pre-determined so that an automatic code generator (BAC constructor 906) can be written to generate the changes (i.e., to generate the customized BAC such as a customized ARM). For example, augmented discovery tool 904 may discover a WAS cluster and an ORACLE cluster, identified as easily cloudifiable applications. CASE module 906 now generates an ARM 908 for a WAS cluster and an ORACLE cluster. ARM templates 912 will include generic code for various operations required for each customized ARM; for example, generic code lines to increase the size of a WAS cluster. These generic code lines will include blanks, dummy values (“X”), or the like for specifying the actual particular WAS cluster, node(s), etc. of interest in the given case; these are filled in with the correct values by BAC constructor module 906. BAC template store 912 will thus include generic (blank) templates for increasing or decreasing the amount of resources for the application(s) of interest, e.g. WAS cluster, ORACLE cluster. BAC constructor module 906 thus instantiates particular instances of the generic templates 912 including the particular machines, addresses, etc. for the migration of interest. For example, if the WAS management node is WASND1 and “X” is the dummy value in the template representing the WAS management node, the BAC constructor module will instantiate an instance of the WAS cluster resource-increasing code with “WASND1” substituted for “X.”

In one or more embodiments, the step of analyzing the infrastructures of the plurality of existing applications of the entity to identify at least one of the infrastructures of the plurality of existing applications which includes existing substructures enabling replication of individual parts via an existing replication mechanism includes identifying the substructures by identifying replication management nodes from configuration files of the replication management nodes; identifying configurations of replicated servers; and/or identifying configurations of other servers that connect to the replicated servers.

### Exemplary System and Article of Manufacture Details

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit” “module” or “system.” Furthermore, aspects of the present invention may take the form of a computer program product embodied in one or more computer readable medium(s) having computer readable program code embodied thereon.

One or more embodiments of the invention, or elements thereof, can be implemented in the form of an apparatus including a memory and at least one processor that is coupled to the memory and operative to perform exemplary method steps.

One or more embodiments can make use of software running on a general purpose computer or workstation. With reference to FIG. 1, such an implementation might employ, for example, a processor 16, a memory 28, and an input/output interface 22 to a display 24 and external device(s) 14 such as a keyboard, a pointing device, or the like. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory) 30, ROM (read only memory), a fixed memory device (for example, hard drive 34), a removable memory device (for example, diskette), a flash memory and the like. In addition, the phrase “input/output interface” as used herein, is intended to contemplate an interface to, for example, one or more mechanisms for inputting data to the processing unit (for example, mouse), and one or more mechanisms for providing results associated with the processing unit (for example, printer). The processor 16, memory 28, and input/output interface 22 can be interconnected, for example, via bus 18 as part of a data processing unit 12. Suitable interconnections, for example via bus 18, can also be provided to a network interface 20, such as a network card, which can be provided to interface with a computer network, and to a media interface, such as a diskette or CD-ROM drive, which can be provided to interface with suitable media.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 16 coupled directly or indirectly to memory elements 28 through a system bus 18. The memory elements can include local memory employed during actual implementation of the program code, bulk storage, and cache memories 32 which provide temporary storage of at least some program code in order to reduce the number of times code must be retrieved from bulk storage during implementation.

Input/output or I/O devices (including but not limited to keyboards, displays, pointing devices, and the like) can be coupled to the system either directly or through intervening I/O controllers.

Network adapters 20 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 12 as shown in FIG. 1) running a server program. It will be understood that such a physical server may or may not include a display and keyboard.

As noted, aspects of the present invention may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages, or a scripting language such as Perl. In some instances, an optimizing solver may be used as a subcomponent, e.g., ILOG CPLEX (a high-performance mathematical programming solver for linear programming, mixed integer programming, and quadratic programming, available from International Business Machines Corporation, Armonk, N.Y., USA). In general terms, the program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In one or more embodiments, a significant portion of the code is that associated with the application resource manager; it may run in the cloud or outside. In at least some cases, it is more likely to be on a server than on an end-user machine (if at all, then an end user machine of the application owner), but it is not impossible that the application owner would run it from a laptop or the like. With respect to the augmented discovery tool 904, at least a portion (e.g., scripts or agents) typically runs on the legacy system 902, while another portion runs on a dedicated server. However, the entire augmented discovery tool could run on a dedicated server with a connection or connections to the legacy system. In some instances, the entire augmented discovery tool could run on the legacy system. With respect to the BAC constructor module, the same typically runs on a dedicated server. However, it could be located in a cloud or even on the legacy system (the latter is believed to be more appropriate if a company's internal IT department carries out the entire procedure as an external consultant is likely to want to run the BAC constructor module on its own dedicated server).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the elements depicted in the block diagrams and/or described herein; by way of example and not limitation, an application resource manager module with one or more sub-modules such as a policies sub-module, a management sub-module, a control sub-modules, and an interpretation sub-module as illustrated in FIG. 6. In another aspect, a suitable (augmented) discovery tool module 904, migration tool module 914, BAC constructor module 906, and business agility component module (e.g., customized BAC 908 such as a customized ARM) could be employed, together with other component(s) shown in FIG. 9. The method steps can then be carried out or otherwise facilitated using the distinct software modules and/or sub-modules of the system, as described above, executing on one or more hardware processors such as 16. For example, the analyzing step 702 could be carried out by the discovery tool module executing on at least one hardware processor; the selecting step 704 could be facilitated by the discovery tool module executing on the at least one hardware processor (for example, by aiding a human expert or other human user); the migrating step 706 could be carried out by the migration tool module executing on the at least one hardware processor; and the assembling step 708 could be carried out by the BAC constructor module executing on the at least one hardware processor. Step 710 is then carried out by the business agility component in the form of a business agility component module executing on the at least one hardware processor. In a preferred approach, the at least one processor includes at least two processors; steps prior to 710 are performed by a first processor, and step 710 is then carried out by the business agility component in the form of a business agility component module executing on a second processor, since step 710 is not part of the migration process, but is the actual migrated application running in the new environment. The first and/or second processors could each be multiple processors in some cases. Further, a computer program product can include a computer-readable storage medium with code adapted to be implemented to carry out one or more method steps described herein, including the provision of the system with the distinct software modules.

In any case, it should be understood that the components illustrated herein may be implemented in various forms of hardware, software, or combinations thereof; for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
analyzing infrastructures of a plurality of existing applications of an entity to identify at least one of said infrastructures of said plurality of existing applications which comprises existing substructures enabling replication of individual parts via an existing replication mechanism;
selecting said at least one of said infrastructures for migration to a cloud, said cloud comprising at least one of an infrastructure as a service cloud and a platform as a service cloud;
migrating said existing substructures of said at least one of said infrastructures to said cloud, without application-level change;
assembling a business agility component configured to control extending and shrinking resources of said cloud that are devoted to said at least one of said infrastructures; and
extending and shrinking said resources of said cloud that are devoted to said at least one of said infrastructures, using said business agility component.

2. The method of claim 1, further comprising running an infrastructure discovery tool to obtain information for said analyzing step.

3. The method of claim 1, wherein said substructures of said at least one of said infrastructures identified in said identifying step comprise clusters.

4. The method of claim 3, wherein said clusters of said at least one of said infrastructures identified in said identifying step comprise at least one of web server clusters, application server clusters, and database clusters.

5. The method of claim 1, wherein said business agility component assembled in said assembling step is further configured to assess changes in need which will drive said extending and shrinking of said resources of said cloud that are devoted to said at least one of said infrastructures, further comprising assessing said changes in said need.

6. The method of claim 1, wherein said step of analyzing said infrastructures of said plurality of existing applications of said entity to identify at least one of said infrastructures of said plurality of existing applications which comprises existing substructures enabling replication of individual parts via an existing replication mechanism comprises identifying said substructures by at least one of:
identifying replication management nodes from configuration files of said replication management nodes;
identifying configurations of replicated servers; and
identifying configurations of other servers that connect to said replicated servers.

7. The method of claim 1, wherein said assembling step comprises:
identifying, in a business agility component template store, at least one generic template comprising instructions for carrying out at least one of extending and shrinking resources of said cloud that are to be devoted to said at least one of said infrastructures;
instantiating a particular instance of said at least one generic template by populating said at least one generic template with specific data pertaining to said at least one of said infrastructures; and
assembling, from at least said particular instance, said business agility component.

8. The method of claim 1, wherein, in said migrating step, said cloud comprises said infrastructure as a service cloud.

9. The method of claim 8, wherein said extending and shrinking of said resources comprises extending and shrinking using said existing replication mechanism while using an infrastructure of said infrastructure as a service cloud to carry out at least one of provisioning, de-provisioning, stashing, and restoring corresponding operating system images.

10. The method of claim 1, wherein, in said migrating step, said cloud comprises said platform as a service cloud.

11. The method of claim 10, wherein said extending and shrinking of said resources comprises at least extending by provisioning, on said platform as a service cloud, images comprising base software associated with said substructures.

12. The method of claim 1, wherein said extending and shrinking of said resources of said cloud that are devoted to said at least one of said infrastructures, using said business agility component, is carried out at a level of said substructures.

13. The method of claim 12, wherein said carrying out of said extending and shrinking at said level of said substructures is based on performance monitoring of said substructures.

14. The method of claim 12, wherein said carrying out of said extending and shrinking at said level of said substructures is based on performance predictions for said substructures.

15. The method of claim 1, further comprising providing a system, wherein the system comprises distinct software modules, each of the distinct software modules being embodied on a computer-readable storage medium, and wherein the distinct software modules comprise a discovery tool module, a migration tool module, and a business agility component constructor tool module;
wherein:
said analyzing step is carried out by said discovery tool module executing on at least one hardware processor;
said selecting step is facilitated by said discovery tool module executing on said at least one hardware processor;
said migrating step is carried out by said migration tool module executing on said at least one hardware processor; and
said assembling step is carried out by said business agility component constructor tool module executing on said at least one hardware processor.

16. An article of manufacture comprising a computer program product, said computer program product comprising:
a non-transitory tangible computer-readable storage medium, storing in a non-transitory manner computer readable program code, the computer readable program code comprising:
computer readable program code configured to analyze infrastructures of a plurality of existing applications of an entity to identify at least one of said infrastructures of said plurality of existing applications which comprises existing substructures enabling replication of individual parts via an existing replication mechanism;
computer readable program code configured to facilitate selecting said at least one of said infrastructures for migration to a cloud, said cloud comprising at least one of an infrastructure as a service cloud and a platform as a service cloud;
computer readable program code configured to facilitate migrating said existing substructures of said at least one of said infrastructures to said cloud, without application-level change; and
computer readable program code configured to assemble a business agility component configured to control extending and shrinking resources of said cloud that are devoted to said at least one of said infrastructures.

17. The article of manufacture of claim 16, wherein said substructures of said at least one of said infrastructures identified by said computer readable program code configured to analyze said infrastructures comprise clusters.

18. The article of manufacture of claim 17, wherein said clusters of said at least one of said infrastructures identified in by said computer readable program code configured to analyze said infrastructures comprise at least one of web server clusters, application server clusters, and database clusters.

19. The article of manufacture of claim 16, wherein said business agility component assembled by said computer readable program code configured to assemble is further configured to assess changes in need which will drive said extending and shrinking of said resources of said cloud that are devoted to said at least one of said infrastructures.

20. The article of manufacture of claim 19, wherein said computer readable program code configured to analyze said infrastructures of said plurality of existing applications of said entity to identify at least one of said infrastructures of said plurality of existing applications which comprises existing substructures enabling replication of individual parts via an existing replication mechanism comprises computer readable program code configured to identify said substructures by at least one of:
identifying replication management nodes from configuration files of said replication management nodes;
identifying configurations of replicated servers; and
identifying configurations of other servers that connect to said replicated servers.

21. The article of manufacture of claim 19, wherein said computer readable program code configured to assemble comprises:
computer readable program code configured to identify, in a business agility component template store, at least one generic template comprising instructions for carrying out at least one of extending and shrinking resources of said cloud that are to be devoted to said at least one of said infrastructures;
computer readable program code configured to instantiate a particular instance of said at least one generic template by populating said at least one generic template with specific data pertaining to said at least one of said infrastructures; and
computer readable program code configured to assemble, from at least said particular instance, said business agility component.

22. An apparatus comprising:
a memory; and
at least one processor, coupled to said memory, and operative to:
analyze infrastructures of a plurality of existing applications of an entity to identify at least one of said infrastructures of said plurality of existing applications which comprises existing substructures enabling replication of individual parts via an existing replication mechanism;
facilitate selecting said at least one of said infrastructures for migration to a cloud, said cloud comprising at least one of an infrastructure as a service cloud and a platform as a service cloud;
facilitate migrating said existing substructures of said at least one of said infrastructures to said cloud, without application-level change;
assemble a business agility component configured to control extending and shrinking resources of said cloud that are devoted to said at least one of said infrastructures; and
execute said business agility component to extend and shrink said resources of said cloud that are devoted to said at least one of said infrastructures.

23. The apparatus of claim 22, further comprising a plurality of distinct software modules, each of the distinct software modules being embodied on a computer-readable storage medium, and wherein the distinct software modules comprise a discovery tool module, a migration tool module, and a business agility component constructor module;
wherein:
said at least one processor is operative to analyze said infrastructures by executing said discovery tool module;
said at least one processor is operative to facilitate selecting said at least one of said infrastructures for migration to said cloud by executing said discovery tool module;
said at least one processor is operative to facilitate migrating said existing substructures of said at least one of said infrastructures to said cloud by executing said migration tool module; and
said at least one processor is operative to assemble said business agility component by executing said business agility component constructor module.

24. A method comprising:
obtaining a specification of at least one infrastructure of a plurality of infrastructures of a plurality of existing applications of an entity that is to be migrated to a cloud, said at least one infrastructure comprising existing substructures enabling replication of individual parts via an existing replication mechanism;
identifying, in a business agility component template store, at least one generic template comprising instructions for carrying out at least one of extending and shrinking resources of said cloud that are to be devoted to said at least one infrastructure;
instantiating a particular instance of said at least one generic template by populating said at least one generic template with specific data pertaining to said at least one infrastructure; and
assembling, from at least said particular instance, a business agility component configured to control said at least one of extending and shrinking said resources of said cloud that are devoted to said at least one infrastructure.

25. The method of claim 24, further comprising providing a system, wherein the system comprises distinct software modules, each of the distinct software modules being embodied on a computer-readable storage medium, and wherein the distinct software modules comprise a business agility component constructor module and an application resource manager template module;
wherein:
said obtaining, instantiating, and assembling steps are carried out by said business agility component constructor module executing on at least one hardware processor; and
said identifying step is carried out by said business agility component constructor module, executing on said at least one hardware processor, accessing said business agility component template module.
